(19) United States
(12) Patent Application Publication
(10) Pub. No.: US 2011/0014952 A1
(43) Pub. Date: Jan. 20, 2011

(54) AUDIO RECOGNITION DURING VOICE SESSIONS TO PROVIDE ENHANCED USER INTERFACE FUNCTIONALITY

(75) Inventor: Wayne Christopher MINTON, Lund (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 12/503,410

(22) Filed: Jul. 15, 2009

(51) Int. Cl. H04M 1/00; G06F 3/041; G10L 15/00; G10L 21/00; G06F 3/02; G06F 3/16

(52) U.S. Cl. 455/566; 345/173; 704/251; 704/275; 345/168; 715/728

(57) ABSTRACT

The user interface for a mobile communication device may be provided based on the current context of a voice session, as recognized by an automated audio recognition engine. In one implementation, the mobile device may transcribe, by an audio recognition engine in the mobile device, audio from a voice session conducted through the mobile device; detect, by the mobile device and based at least on the transcribed audio, changes in context during the voice session that relate to a change in functionality of the user interface of the mobile device; and update, by the mobile device, the user interface in response to the detected change in context.

### BACKGROUND

Many electronic devices provide an option for a user to enter information. For example, a mobile communication device (e.g., a cell phone) may use an input device, such as a keypad or a touch screen, for receiving user input. A keypad may send a signal to the device when a user pushes a button on the keypad. A touch screen may send a signal to the device when a user touches it with a finger or a pointing device, such as a stylus.

In order to maximize portability, manufacturers frequently design mobile communication devices to be as small as possible. One problem associated with small communication devices is that there may be limited space for the user interface. For example, the size of a display, such as the touch screen display, may be relatively small. The small screen size may make it difficult for the user to easily interact with the mobile communication device.

### SUMMARY

According to one implementation, a method may include presenting, by a mobile device, a user interface through which a user of the mobile device interacts with the mobile device; and transcribing, by an audio recognition engine in the mobile device, audio from a voice session conducted via the mobile device. The method may further include detecting, by the mobile device and based at least on the transcribed audio, changes in context during the voice session that relate to a change in functionality of the user interface of the mobile device; and updating, by the mobile device, the user interface in response to the detected change in context.

Additionally, the user interface may be presented through a touch screen display.

Additionally, detecting the changes in the context may include matching the transcribed audio to one or more pre-stored phrases.

Additionally, detecting the changes in context may include detecting the changes as changes corresponding to prompts from an interactive voice response system.

Additionally, updating the user interface may include updating a visual numeric key pad configured to accept numeric input from the user.

Additionally, updating the user interface may include updating the user interface to include interactive elements generated dynamically based on the voice session.

Additionally, the method may include detecting changes in the context only for select telephone numbers corresponding to the voice session.

Additionally, detecting the changes in the context may further include detecting changes in the context in response to an explicit indication from the user that the voice session is one for which context changes should be detected.

In another implementation, a mobile communication device may include a touch screen display; an audio recognition engine to receive audio from a called party during a voice session through the mobile communication device; a context match component to receive an output of the audio recognition engine and, based on the output, determine whether to update a user interface presented on the touch screen display; and a user interface control component to control the touch screen display to present the updated user interface.

Additionally, the context match component may update the user interface to include additional functionality relevant to a current context of the voice session.

Additionally, the audio recognition engine may output a transcription of audio received from the called party.

Additionally, the audio recognition engine may output an indication of commands recognized in audio corresponding to the called party.

Additionally, the context match component may determine whether to update the user interface based on a matching of the output of the audio recognition engine to one or more pre-stored phrases.

Additionally, the user interface control component may update the user interface to include a visual numeric key pad configured to accept numeric input from the user.

Additionally, the user interface control component may update the user interface to include interactive elements generated dynamically based on the voice session.

Additionally, the context match component may determine whether to update the user interface for select telephone numbers corresponding to the voice session.

Additionally, the context match component may determine whether to update the user interface in response to an explicit indication from the user that the voice session is one that should be monitored by the context match component.

In yet another implementation, a mobile device may include means for presenting a user interface through which a user of the mobile device interacts with the mobile device; means for transcribing audio from a voice session conducted through the mobile device; means for detecting, based at least on the transcribed audio, changes in context during the voice session that relate to a change in functionality of the user interface of the mobile device; and means for updating the user interface in response to the detected change in context.

Additionally, the means for detecting may detect the changes in context as a change corresponding to prompts from an interactive voice response system.

Additionally, the mobile device may include means for detecting the changes in context as a change corresponding to prompts from an interactive voice response system.

### BRIEF DESCRIPTION OF THE DRAWINGS

The accompanying drawings, which are incorporated in and constitute a part of this specification, illustrate exemplary embodiments described herein and, together with the description, explain these exemplary embodiments. In the drawings:

FIG. 1 is a diagram illustrating an overview of an exemplary environment in which concepts described herein may be implemented;

FIG. 2 is a diagram of an exemplary mobile device in which the embodiments described herein may be implemented;

FIG. 3 is a diagram illustrating exemplary components of the mobile device shown in FIG. 2;

FIG. 4 is a diagram of exemplary functional components of the context aware user interface tool shown in FIG. 3;

FIG. 5 is a flow chart illustrating exemplary operations that may be performed by the context aware user interface tool shown in FIGS. 3 and 4;

FIG. 6 is a diagram conceptually illustrating an exemplary implementation of the context match component shown in FIG. 3; and

FIGS. 7A-7D are diagrams illustrating exemplary user interfaces displayed on a touch screen display;

FIGS. 8A-8D are diagrams illustrating additional exemplary user interfaces displayed on a touch screen display; and

FIGS. 9A-9D are diagrams illustrating additional exemplary user interfaces displayed on a touch screen display.

### DETAILED DESCRIPTION

The following detailed description refers to the accompanying drawings. The same reference numbers in different drawings may identify the same or similar elements. Also, the following description does not limit the invention.

### Overview

Exemplary implementations described herein may be provided in the context of a mobile communication device (or mobile terminal). A mobile communication device is an example of a device that can employ a user interface design as described herein, and should not be construed as limiting of the types or sizes of devices that can use the user interface design described herein.

When using a mobile communication device, users may enter information using an input device of the mobile communication device. For example, a user may enter digits to dial a phone number or respond to an automated voice response system using a touch screen display, or via another data entry technique. In some situations, the size of the touch screen display may not be big enough to display all of the options that could ideally be displayed to the user.

The user interface for a touch screen display may be provided based on the current context of a voice session, as recognized by an automated audio recognition engine. For example, the audio recognition engine may recognize certain audio prompts received at the mobile communication device, such as “press one for support,” and in response, switch the touch screen display to an appropriate interface, such as, in this example, an interface displaying buttons through which the user may select the digits zero through nine.

### System Overview

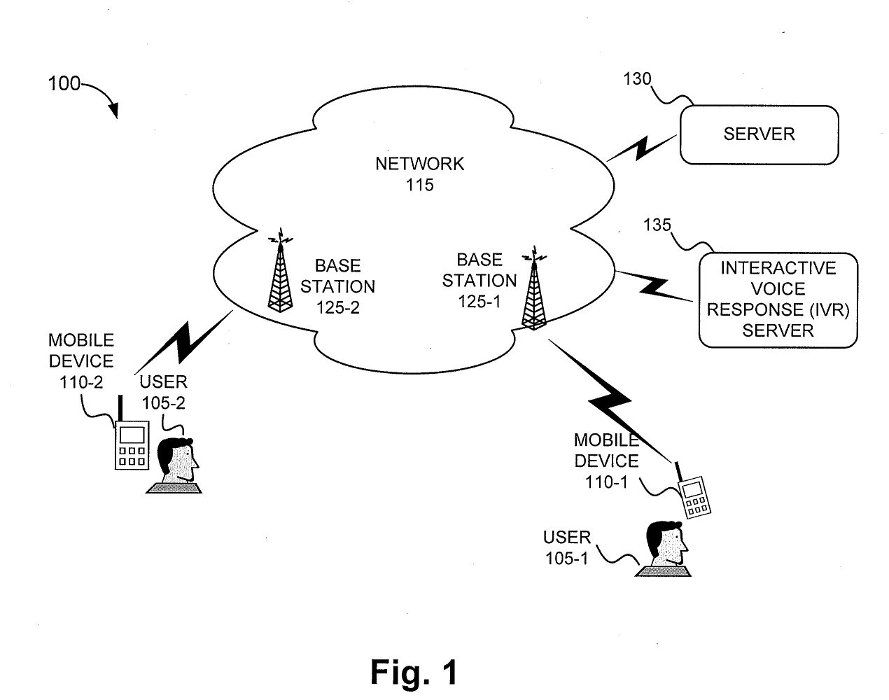

FIG. 1 is a diagram illustrating an overview of an exemplary environment in which concepts described herein may be implemented. As illustrated, environment 100 may include users 105-1 and 105-2 (referred to generally as a “user 105”) operating mobile devices 110-1 and 110-2 (referred to generally as a “mobile device 110”), respectively. Mobile devices 110-1 and 110-2 may be communicatively coupled to network 115 via base stations 125-1 and 125-2, respectively.

Environment 100 may additionally include a number of servers that may provide data services or other services to mobile devices 110. As particularly shown, environment 100 may include a server 130 and an interactive voice response (IVR) server 135. Each of servers 130 and 135 may include one or more co-located or distributed computing devices designed to provide services to mobile devices 110. IVR server 135 may be particularly designed to allow users 105 to interact with a database, such as a company database, using automated logic to recognize user input and provide appropriate responses. In general, IVR systems may allow users to service their own enquiries by navigating an interface broken down into a series of simple menu choices. IVR systems can respond with pre-recorded or dynamically generated audio to further direct users on how to proceed.

In an exemplary scenario, a user, such as user 105-1, may connect, via a voice session, to one of servers 130 or 135, or with another user 105. Mobile device 110-1 may monitor the voice session and update or change an interface presented to the user based on context sounds or phrases detected in the voice session. For instance, a touch screen display of mobile device 110-1 may be updated to provide user 105-1 with menu “buttons” that are currently appropriate for the voice session. Advantageously, mobile devices that include physically small interfaces, such as a relatively small touch screen display, can optimize the effectiveness of the interface by presenting different choices to the user based on the current voice session context.

### Exemplary Device

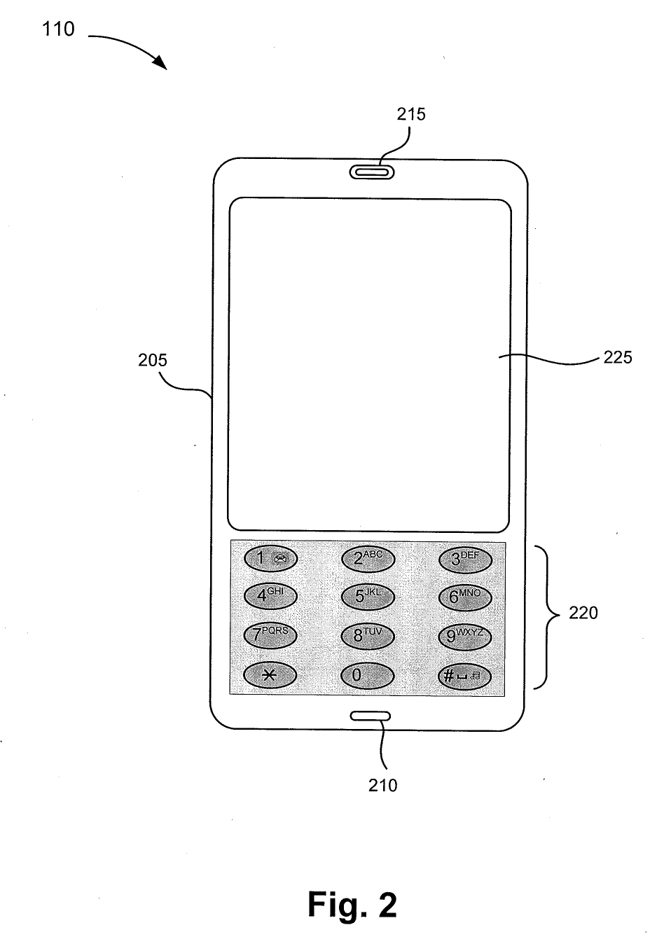

FIG. 2 is a diagram of an exemplary mobile device 110 in which the embodiments described herein may be implemented. Mobile device 110 may include a portable computing device or a handheld device, such as a wireless telephone (e.g., a smart phone or a cellular phone), a personal digital assistant (PDA), a pervasive computing device, a computer, or another kind of communication device.

As illustrated in FIG. 2, mobile device 110 may include a housing 205, a microphone 210, a speaker 215, a keypad 220, and a display 225. In other embodiments, mobile device 110 may include fewer, additional, and/or different components, or a different arrangement of components than those illustrated in FIG. 2 and described herein. For example, mobile device 110 may include a camera, a video capturing component, and/or a flash for capturing images and/or video.

Housing 205 may include a structure to contain components of mobile device 110. For example, housing 205 may be formed from plastic, metal, or some other material. Housing 205 may support microphone 210, speaker 215, keypad 220, and display 225.

Microphone 210 may transduce a sound wave to a corresponding electrical signal. For example, a user may speak into microphone 210 during a telephone call or to execute a voice command. Speaker 215 may transduce an electrical signal to a corresponding sound wave. For example, a user may listen to music or listen to a calling party through speaker 215. Speaker 215 may include multiple speakers.

Keypad 220 may provide input to user device 110. Keypad 220 may include a standard telephone keypad, a QWERTY keypad, and/or some other type of keypad. Keypad 220 may also include one or more special purpose keys. In one implementation, each key of keypad 220 may be, for example, a pushbutton. A user may utilize keypad 220 for entering information, such as text, or for activating a special function.

Display 225 may output visual content and may operate as an input component (e.g., a touch screen). For example, display 225 may include a liquid crystal display (LCD), a plasma display panel (PDP), a field emission display (FED), a thin film transistor (TFT) display, or some other type of display technology. Display 225 may display, for example, text, images, and/or video to a user.

In one implementation, display 225 may include a touch-sensitive screen to implement a touch screen display 225. Display 225 may correspond to a single-point input device (e.g., capable of sensing a single touch) or a multipoint input device (e.g., capable of sensing multiple touches that occur at the same time). Touch screen display 225 may implement, for example, a variety of sensing technologies, including but not limited to, capacitive sensing, surface acoustic wave sensing, resistive sensing, optical sensing, pressure sensing, infrared sensing, gesture sensing, etc. Touch screen display 225 may display various images (e.g., icons, a keypad, etc.) that may be selected by a user to access various applications and/or enter data. Although touch screen display 225 will be generally described herein as an example of an input device, it can be appreciated that a user may input information to mobile device 110 using other techniques, such as through keypad 220.

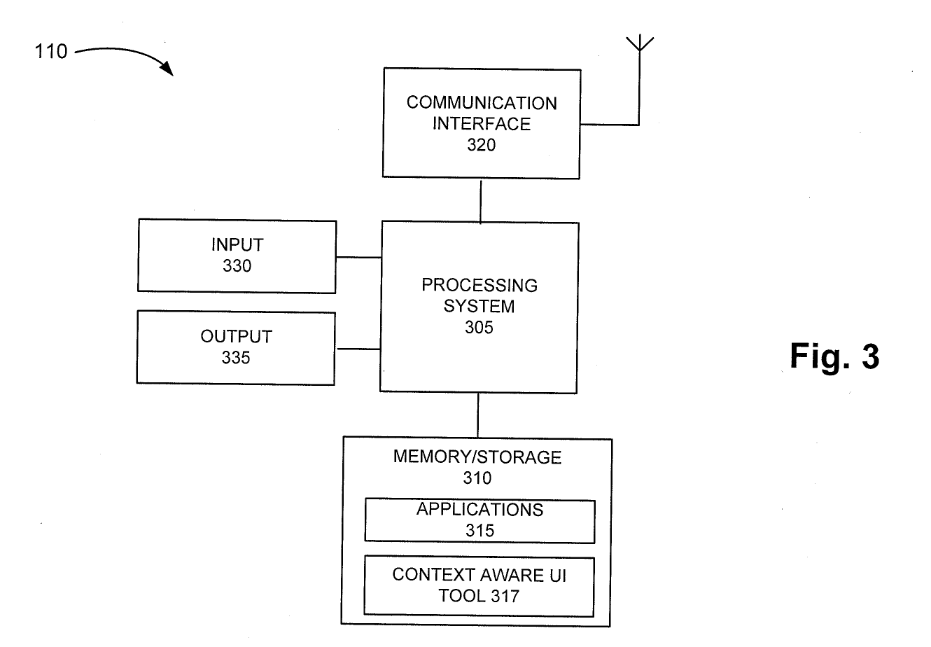

FIG. 3 is a diagram illustrating exemplary components of mobile device 110. As illustrated, mobile device 110 may include a processing system 305, a memory/storage 310 (e.g., containing applications 315 and a context aware user interface (UI) tool 317), a communication interface 320, an input 330, and an output 335. In other embodiments, mobile device 110 may include fewer, additional, and/or different components, or a different arrangement of components than those illustrated in FIG. 3 and described herein.

Processing system 305 may include one or multiple processors, microprocessors, data processors, co-processors, network processors, application specific integrated circuits (ASICs), controllers, programmable logic devices, chipsets, field programmable gate arrays (FPGAs), and/or some other component that may interpret and/or execute instructions and/or data. Processing system 305 may control the overall operation (or a portion thereof) of user device 110 based on an operating system and/or various applications.

Processing system 305 may access instructions from memory/storage 310, from other components of mobile device 110, and/or from a source external to user device 110 (e.g., a network or another device). Processing system 305 may provide for different operational modes associated with mobile device 110. Additionally, processing system 305 may operate in multiple operational modes simultaneously. For example, processing system 305 may operate in a camera mode, a music playing mode, a radio mode (e.g., an amplitude modulation/frequency modulation (AM/FM) mode), and/or a telephone mode.

Memory/storage 310 may include memory and/or secondary storage. For example, memory/storage 310 may include a random access memory (RAM), a dynamic random access memory (DRAM), a read only memory (ROM), a programmable read only memory (PROM), a flash memory, and/or some other type of memory. Memory/storage 310 may include a hard disk (e.g., a magnetic disk, an optical disk, a magneto-optic disk, a solid state disk, etc.) or some other type of computer-readable medium, along with a corresponding drive. The term “computer-readable medium,” as used herein, is intended to be broadly interpreted to include a memory, a secondary storage, a compact disc (CD), a digital versatile disc (DVD), or the like. For example, a computer-readable medium may be defined as a physical or logical memory device. A logical memory device may include memory space within a single physical memory device or spread across multiple physical memory devices.

Memory/storage 310 may store data, application(s), and/or instructions related to the operation of mobile device 110. For example, memory/storage 310 may include a variety of applications 315, such as, an e-mail application, a telephone application, a camera application, a voice recognition application, a video application, a multi-media application, a music player application, a visual voicemail application, a contacts application, a data organizer application, a calendar application, an instant messaging application, a texting application, a web browsing application, a location-based application (e.g., a GPS-based application), a blogging application, and/or other types of applications (e.g., a word processing application, a spreadsheet application, etc.). Consistent with implementations described herein, applications 315 may include an application that allows or updates the user interface, such as the interface presented on touch screen display 225, during a voice communication session based on a content of the session. Such an application is particularly illustrated in FIG. 3 as context aware user interface (UI) tool 317.

Communication interface 320 may permit user device 110 to communicate with other devices, networks, and/or systems. For example, communication interface 320 may include an Ethernet interface, a radio interface, a microwave interface, or some other type of wireless and/or wired interface. Communication interface 320 may include a transmitter and a receiver.

Input 330 may permit a user and/or another device to input information to user device 110. For example, input 330 may include a keyboard, microphone 210, keypad 220, display 225, a touchpad, a mouse, a button, a switch, an input port, voice recognition logic, and/or some other type of input component. Output 335 may permit user device 110 to output information to a user and/or another device. For example, output 335 may include speaker 215, display 225, one or more light emitting diodes (LEDs), an output port, a vibrator, and/or some other type of visual, auditory, tactile, etc., output component.

### Context Aware User Interface

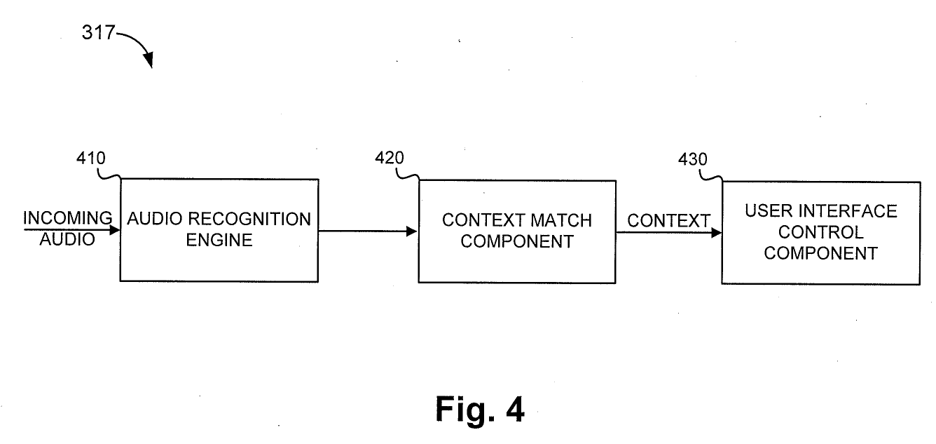

FIG. 4 is a diagram of exemplary functional components of context aware user interface tool 317, which may be implemented in one of mobile devices 110 to provide a context aware user interface during a voice session. As particularly shown, context aware user interface tool 317 may include an audio recognition engine 410, a context match component 420, and a user interface control component 430. The functionality shown in FIG. 4 may generally be implemented using the components of mobile device 110 shown in FIG. 3. For instance, audio recognition engine 410, context match component 420, and user interface control component may be implemented by software (i.e., context aware user interface tool 317) and executed by processing system 305.

Audio recognition engine 410 may include logic to automatically recognize audio, such as voice, received by mobile device 110. Audio recognition engine 410 may be particularly designed to convert spoken words, received as part of a voice session by mobile device 110, to machine readable input (e.g., text). In other implementations, audio recognition engine 410 may include the ability to be directly configured to recognize certain pre-configured vocal commands and output an indication of the recognized command. Audio recognition engine 410 may receive input audio data from communication interface 320.

Audio recognition engine 410 may output an indication of the recognized words, sounds, or commands to context match component 420. Context match component 420 may, based on the input from audio recognition engine 410, determine if the current context of the voice session indicates that the interface should be updated. In one implementation, context match component 420 may determine context matches based on the recognition of certain words or phrases in the input audio.

User interface control component 430 may control the user interface of mobile device 110. For example, user interface control component 430 may control touch screen display 225. User interface control component 430 may display information on display 225 that can include icons, such as graphical buttons, through which the user may interact with mobile device 110. User interface control component 430 may update the user interface based, at least in part, on the current context detected by content match component 420.

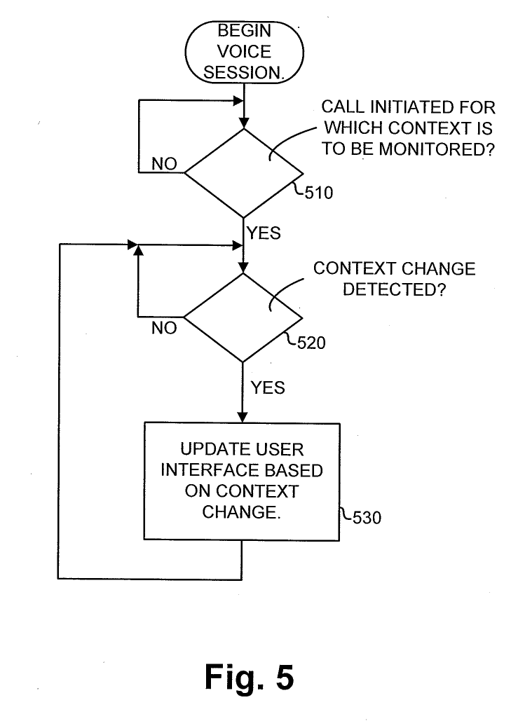

FIG. 5 is a flow chart illustrating exemplary operations that may be performed by context aware user interface tool 317.

Context aware user interface tool 317 may generally monitor telephone calls of mobile device 110 to determine if the context of a call indicates a change in context associated with the a new user interface. For a voice session, context aware user interface tool 317 may determine whether the voice session is one for which calls are to be monitored (block 510). In various implementations, context aware user interface tool 317 may operate for all voice sessions; during select voice sessions, such as only when explicitly enabled by the user; or during voice sessions selected automatically, such as during voice sessions that correspond to particular called parties or numbers. As an example, assume that content match component 420 is particularly configured to determine context changes for IVR systems in which the user may use DTMF (dual-tone multi-frequency) tones to respond to the IVR system. In this case, context aware user interface tool 317 may operate for telephone numbers that are known ahead of time or that can be dynamically determined to be numbers that correspond to IVR systems.

In response to a determination that context is to be monitored for the call (block 510-YES), context aware user interface tool 317 may next determine whether there is a change in context during the voice session (block 520). A change in context, as used herein, refers to a change in context that is recognized by context match component 420 as a context change that should result in an update or change to the user interface presented to the user.

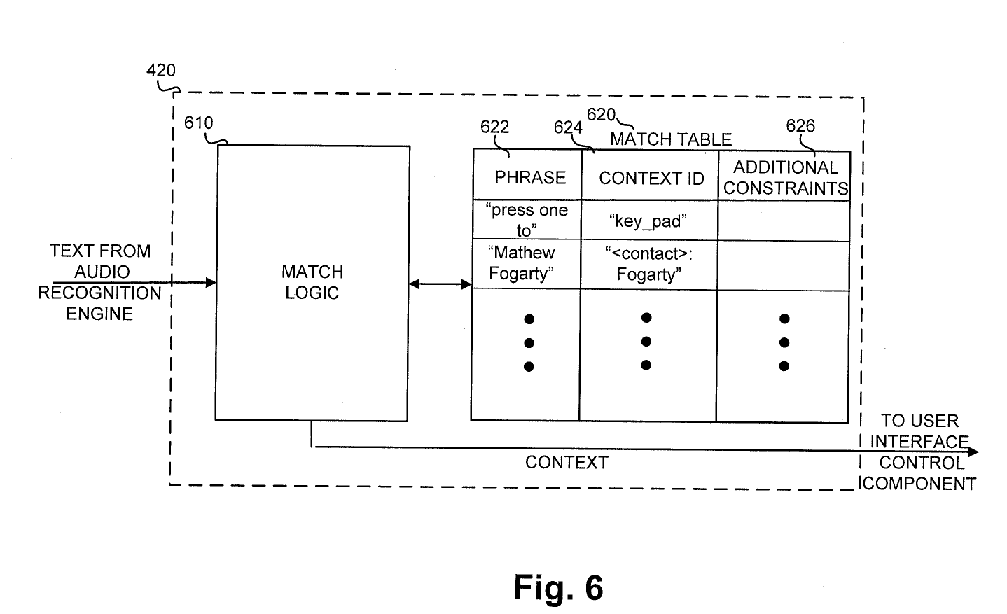

FIG. 6 is a diagram conceptually illustrating an exemplary implementation of context match component 420. Context match component 420 may receive machine-readable data, such as a textual transcription of the current voice session, from audio recognition engine 410. In other implementations, the output of audio recognition engine 410 may be an indication that a certain command, such as a command corresponding to one or more words or phrases, has occurred. Context match component 420 may include match logic 610 and match table 620. Match logic 610 may receive the text from audio recognition engine 410 and determine, via a matching of the text from audio recognition engine 410 to match table 620, whether there is a change in context relevant to the user interface. As a result of the match, match logic 610 may output an indication of whether the current user interface should be changed (shown as “CONTEXT” in FIG. 6).

Match table 620 may include a number of fields that may be used to determine whether a particular context should be output. As shown in FIG. 6, match table 620 may include a phrase field 622, a context identifier (ID) field 624, and an additional constraints field 626. Entries in phrase field 622 may include a word or phrase that corresponds to a particular context. For example, the phrase “press one to” is a common phrase in IVR systems. For instance, an IVR support system may include an audible menu that includes the menu prompt: “press one for technical support, press two for billing issues, . . . ”. Context ID field 624 may include, for each entry, an identifier or description of the user interface that is to be presented to the user for the entry in match table 620. In FIG. 6, text labels are shown to identify user interfaces. For example, the label “key pad” may be associated with a key pad on touch screen display 225. The label “<contact>: Fogarty” may indicate that a user interface that displays contact information for a particular person (in this case, the person “Fogarty”) should be presented.

Additional constraints field 626 may be store additional constraints, other than that stored by phrase field 622, that may be used by match logic 610 in determining whether an entry in match table 620 should be output as a context match. A number of additional constraints are possible and may be associated with additional constraints field 626. Some examples, and without limitation, may include: the telephone number associated with the call; the gender of the other caller (as may be automatically determined by voice recognition engine 410); the location of the user 105 of mobile device 110; or the current time (i.e., context matching may be performed only on certain days or during certain times).

Referring back to FIG. 5, in block 520, match logic 610 may continuously compare, in real-time, incoming text from audio recognition engine 410 to the entries in match table 620. Match logic 610 may output context information (e.g., the information in context ID field 624) in response to a match of an entry in match table 620.

The context information output by context match component 420 may be input to user interface control component 430. User interface control component 430 may update or change the user interface based on the output of context match component 420 (block 530). In one implementation, user interface control component 430 may maintain the “normal” user interface independent of the output of context match component 420. User interface control component 430 may then temporarily modify the normal user interface when context match component 420 outputs an indication that a context-based user interface should be presented.

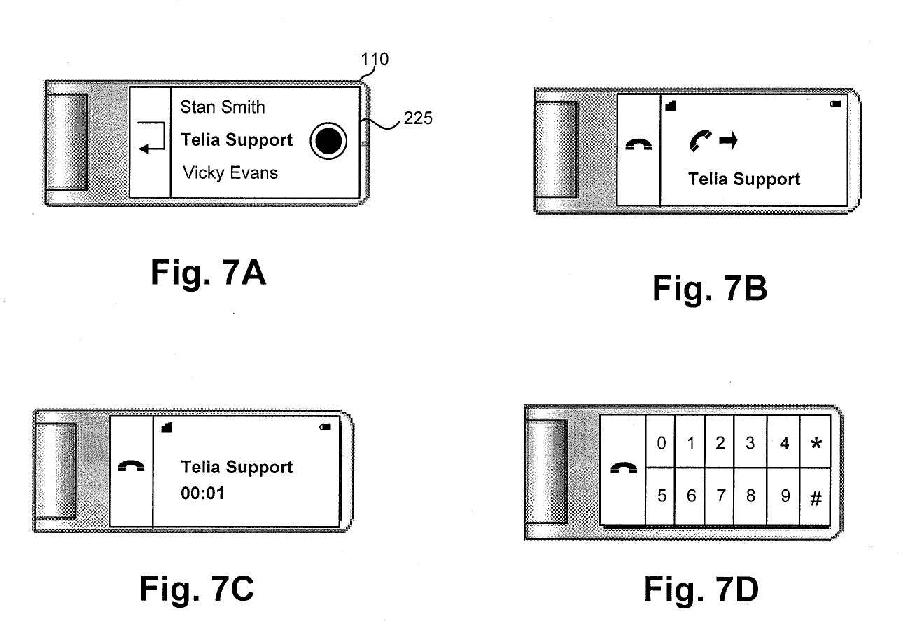

A number of exemplary user interfaces presented on touch screen display 225 and illustrating the updating of the interfaces based on context changes detected by context match component 420 will next be described with reference to FIGS. 7A-7D, 8A-8D, and 9A-9D.

FIGS. 7A-7D are diagrams illustrating user interfaces displayed on touch screen display 225 as a user initiates a voice session with an IVR system that provides technical support.

FIGS. 7A-7C may represent “normal” user interfaces that are shown on touch screen display 225 in response to user interactions with mobile device 110. As shown in FIG. 7A, the user interface may display a contact list through which the user can navigate using touch commands. Assume that the user selects the contact “Telia Support,” which corresponds to an IVR system for the company “Telia.” The user interface may change to a dialing display, as shown in FIG. 7B. In FIG. 7C, the user interface may change, in response to the connection of the voice session, to an interface informing the user that the call has been connected and the current duration of the call. Assume that during the course of the call, the Telia IVR system vocalizes “Welcome to Telia support . . . press 1 for support. Press 2 for billing.” Mobile device 110 may recognize “press 1 for support” as a phrase that matches a “key pad” interface context. In response and as shown in FIG. 7D, mobile device 110 may display a keypad on touch screen display 225. In this manner, the user can more easily interact with the IVR system without having to explicitly control mobile device 110 to enter a number input mode. In the particular example shown in FIG. 7D, touch screen display 225 presents a key pad interface with buttons for the digits 0 through 9, “*” and “#”.

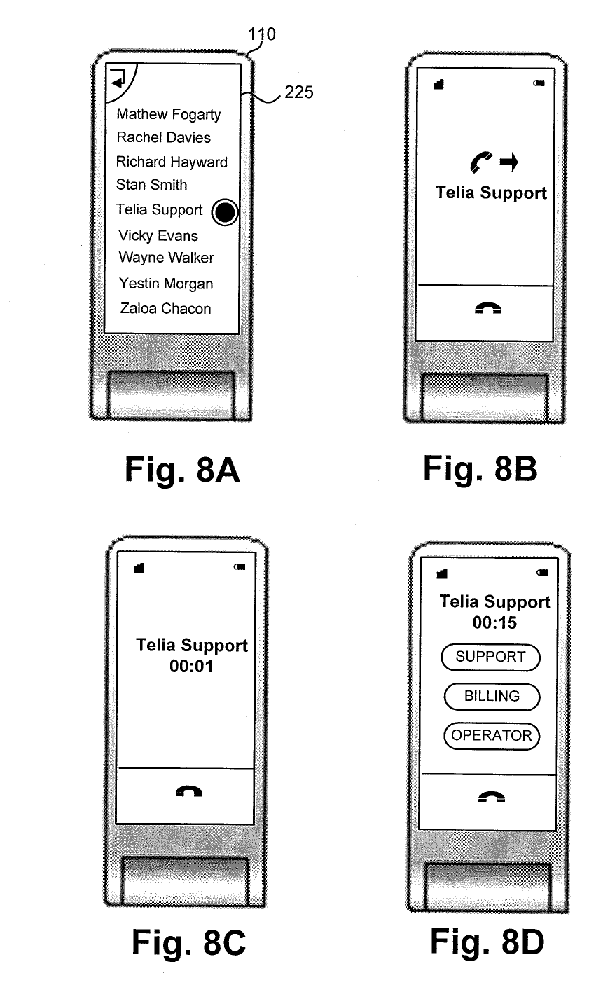

FIGS. 8A-8D are diagrams illustrating another example of user interfaces displayed on touch screen display 225 as a user initiates a voice session with an IVR system that provides technical support.

FIGS. 8A-8C may represent “normal” user interfaces that are shown on the touch screen display 225 in response to user interactions with mobile device 110. As shown in FIG. 8A, the user interface may display a contact list through which the user can navigate using touch commands. Assume that the user selects the contact “Telia Support,” which corresponds to an IVR system for the company “Telia.” The user interface may change to a dialing display, as shown in FIG. 8B. In FIG. 8C, the user interface may change, in response to the connection of the voice session, to an interface illustrating that the call has been connected and the current duration of the call. Assume that during the course of the call, the Telia IVR system vocalizes “Welcome to Telia support . . . press 1 for support. Press 2 for billing.” Mobile device 110 may recognize “press 1 for support” as a phrase that matches a “key pad” interface context. In this implementation, in response to the recognition of the “key pad” interface, mobile device 110, instead of displaying a numeric key pad, may display buttons that include labels describing the action corresponding to each number. The labels may be obtained directly from the voice session by the action of audio recognition engine 410. For example, as shown in FIG. 8D, the button “Support” is shown, which may have been obtained from the audio prompt “press one for support.” Similarly, the button “Billing” may have been obtained from the audio prompt “press 2 for billing.” In other implementations, the labels may be pre-configured for the particular IVR system. In response to a user selecting one of these buttons, mobile device 110 may send the DTMF tone of the number corresponding to the selected button (i.e., “1” for “Support” and “2” for “Billing”).

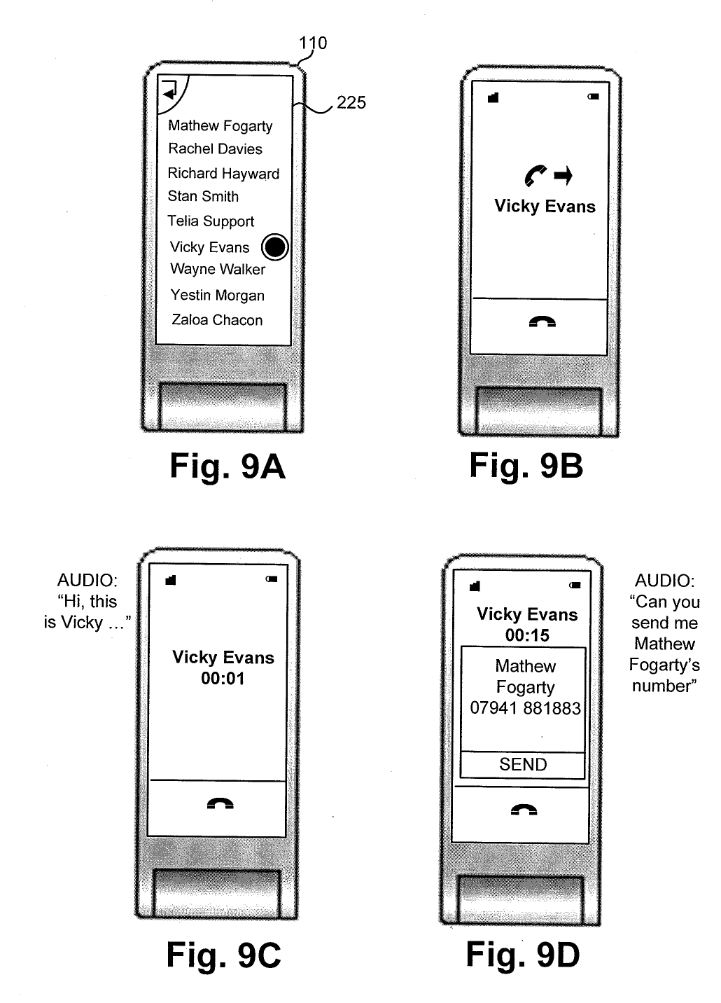

FIGS. 9A-9D are diagrams illustrating another example of user interfaces displayed on touch screen display 225 as a user initiates a voice session with a live person.

FIGS. 9A-9C may represent “normal” user interfaces that are shown on touch screen display 225 in response to user interactions with mobile device 110. As shown in FIG. 9A, the user interface may display a contact list through which the user can navigate using touch commands. Assume that the user selects the contact “Vicky Evans,” who is an acquaintance of the user. The user interface may change to a dialing display, as shown in FIG. 9B. In FIG. 9C, the user interface may change, in response to the connection of the voice session, to an interface illustrating that the call has been connected and the current duration of the call. During the voice session, audio recognition engine 410 may continually monitor the incoming call. As shown in FIG. 9D, in response to recognition of a particular phrase, such as, in this case, a name in the user's contact's list, mobile device may display the contact information stored by mobile device 110 for that name.

Although the context shown in FIGS. 9A-9D relates to contact details for a user, other types of non-IVR context could be detected and acted upon by mobile device 110. For example, in response to the phrase “when is our department meeting,” mobile device 110 may retrieve information from the user's calendar relating to meetings between the user and the called party. In response to the phrase “can you send me the photo you took of us last night,” mobile device 110 may display icons of the most recent photos taken by the user or icons of photos searched by photo metadata (e.g., a specific time/place or people tagged in the photo).

Further, in some implementations, instead of mobile device 110 presenting an updated interface based on data stored on mobile device 110, mobile device 110 may retrieve data over network 115. For example, in response to the phrase “do you know what David is doing today,” mobile device 110 may connect to an online calendar service and retrieve calendar information for David, which may then be presented in an updated interface to the user. As another example, in response to a phrase that mentions “weather,” mobile device 110 mayc connect, via network 115, to a weather service and then display the weather report as part of an updated interface.

As described above, a mobile device with a relatively small display area may increase the effectiveness of the display area by updating the display based on the current context of a conversation. The context may be determined, at least in part, based on automated voice recognition applied to the conversation.

### Conclusion

The foregoing description of implementations provides illustration, but is not intended to be exhaustive or to limit the implementations to the precise form disclosed. Modifications and variations are possible in light of the above teachings or may be acquired from practice of the teachings.

It should be emphasized that the term “comprises” or “comprising” when used in the specification is taken to specify the presence of stated features, integers, steps, or components but does not preclude the presence or addition of one or more other features, integers, steps, components, or groups thereof.

In addition, while a series of blocks has been described with regard to the process illustrated in FIG. 5, the order of the blocks may be modified in other implementations. Further, non-dependent blocks may be performed in parallel. Further one or more blocks may be omitted.

Also, certain portions of the implementations have been described as “logic” or a “component” that performs one or more functions. The terms “logic” or “component” may include hardware, such as a processor, an ASIC, or a FPGA, or a combination of hardware and software (e.g., software running on a general purpose processor that transforms the general purpose processor to a special-purpose processor that functions according to the exemplary processes described above).

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
presenting, by a mobile device, a user interface through which a user of the mobile device interacts with the mobile device;
transcribing, by an audio recognition engine in the mobile device, audio from a voice session conducted through the mobile device;
detecting, by the mobile device and based at least on the transcribed audio, changes in context during the voice session that relate to a change in functionality of the user interface of the mobile device; and
updating, by the mobile device, the user interface in response to the detected change in context.

2. The method of claim 1, where the user interface is presented through a touch screen display.

3. The method of claim 1, where detecting changes in the context includes:
matching the transcribed audio to one or more pre-stored phrases.

4. The method of claim 1, further comprising:
detecting the changes in context as a change corresponding to prompts from an interactive voice response (IVR) system.

5. The method of claim 4, further comprising:
updating the user interface to include a visual numeric key pad configured to accept numeric input from the user.

6. The method of claim 4, further comprising:
updating the user interface to include interactive elements generated dynamically based on the voice session.

7. The method of claim 1, where detecting the changes in the context further includes:
detecting changes in the context for select telephone numbers corresponding to the voice session.

8. The method of claim 6, where detecting the changes in the context further includes:
detecting changes in the context in response to an explicit indication from the user that the voice session is one for which context changes should be detected.

9. A mobile communication device comprising:
a touch screen display;
an audio recognition engine to receive audio from a called party during a voice session through the mobile communication device;
a context match component to:
receive an output of the audio recognition engine, and
based on the output, determine whether to update a user interface presented on the touch screen display; and
a user interface control component to control the touch screen display to present the updated user interface.

10. The mobile communication device of claim 9, where the context match component is further to update the user interface to include additional functionality relevant to a current context of the voice session.

11. The mobile communication device of claim 9, where the audio recognition engine is further to output a transcription of audio received from the called party.

12. The mobile communication device of claim 9, where the audio recognition engine is further to output an indication of commands recognized in audio corresponding to the called party.

13. The mobile communication device of claim 9, where the context match component is further to determine whether to update the user interface based on a matching of the output of the audio recognition engine to one or more pre-stored phrases.

14. The mobile communication device of claim 9, where the user interface control component is further to update the user interface to include a visual numeric key pad configured to accept numeric input from the user.

15. The mobile communication device of claim 9, where the user interface control component is further to update the user interface to include interactive elements generated dynamically based on the voice session.

16. The mobile communication device of claim 9, where the context match component is further to determine whether to update the user interface for select telephone numbers corresponding to the voice session.

17. The mobile communication device of claim 9, where the context match component is further to determine whether to update the user interface in response to an explicit indication from the user that the voice session is one that should be monitored by the context match component.

18. A mobile device comprising:
means for presenting a user interface through which a user of the mobile device interacts with the mobile device;
means for transcribing audio from a voice session conducted through the mobile device;
means for detecting, based at least on the transcribed audio, changes in context during the voice session that relate to a change in functionality of the user interface of the mobile device; and
means for updating the user interface in response to the detected change in context.

19. The device of claim 18, where the means for detecting detects the changes in context as a change corresponding to prompts from an interactive voice response (IVR) system.

20. The device of claim 18, further comprising:
means for detecting the changes in context as a change corresponding to prompts from an interactive voice response (IVR) system.
